(19) United States
(12) Patent Application Publication
(10) Pub. No.: US 2012/0282148 A1
(43) Pub. Date: Nov. 8, 2012

(54) REGENERATION AND RECYCLING EQUIPMENT FOR FERROUS METAL

(76) Inventors: Shinn-Dar WU, Hsinchu City (TW); Chao-Chen Yang, Taichung City (TW); Hsin-Yi Hsu, Taichung City (TW); Sung-Hsiung Kao, Taoyuan City (TW)

(21) Appl. No.: 13/155,078

(22) Filed: Jun. 7, 2011

(30) Foreign Application Priority Data
May 3, 2011 (TW) 100207847

(51) Int. Cl. B01J 19/00

(52) U.S. Cl. 422/187

(57) ABSTRACT

The present invention discloses ferrous metal recycling and regeneration equipment. In the equipment, the recycled ferrous metal is stored in recycled material storage tank, and in acid dissolving tank, acidic solution is added, then ferrous metal is poured in to remove non-ferrous metal impurity, then impurity is filtered through first filtering device, ferrous metal solution is then led to mixing tank, then in mixing tank, element phosphorus (P) is added so that P and Fe can compound into Ferric Phosphate (FePO₄.nH2O, where n can be 2 or 4), then Ferric Phosphate precipitated solution is injected into second filtering device, then through centrifugal force, Ferric Phosphate is separated in different grades, then solid Ferric Phosphate will be obtained through flash dryer from the separated Ferric Phosphate. Therefore, through improved process equipment, the recycling and reproduction of ferrous metal is focused, and the process can be simplified to reduce the defective rate, subsequently, the cost is greatly reduced.

### FIELD OF THE INVENTION

The present invention is related to ferrous metal recycling and regeneration equipment, and it specifically relates to improved process equipment. It is ferrous metal recycling and regeneration equipment that is targeting at the recycling and reproduction of ferrous metal with attempt to simplify the process, to reduce the defective rate, to greatly reduce the cost, and to obtain high quality Ferric Phosphate.

### BACKGROUND OF THE INVENTION

Limited resource topic catches more attention along with the high economic growth of newly emergent countries and the pursuit of rich life in the advanced countries. Therefore, how to take care of the daily life need, material consumption and valuable limited resource has become very popular topic nowadays. Therefore, how to collect, abstract and refine reusable resource from the used material is very important solution to cope with limited resource.

There are lots of resources that can be recycled and reproduced, for example, paper, plastic, oil and metals, etc. Among them, since the development cost of metal is pretty high, the transport cost is high, it can be repeatedly melted and used and it can be recycled and reproduced, hence, the recycling of metal, the abstraction of metal and the reproduction and refinement of metal has become one of the modern industries with very high economic value.

The recyclable metals can be divided into noble metal and non-noble metal according to the price. Noble metals are gold, Pt (platinum), silver and Ti alloy, etc. with very few production and high market price. Non-noble metals are Cu, Fe, Al, etc., and tin, W, Ni, Cr, etc. that are commonly used in the industry, that is, the engineering for recycling metals is so complicated and numerous.

In order to provide convenient service, the current metal recycling supplier usually adopts one stop service, that is, no matter it is Au, Ag, Cu, Fe, Sn, Ni, Cr, W or Ti, as long as it is metallic waste, it is usually accepted. At most, it is divided into noble metal and non-noble metal according to economic value and quantity.

However, the physical and chemical properties of all kinds of metallic elements are quite different. Even for proliferated and large daily use Cu and Fe metals that belong together to non-noble metal, they have pretty different characteristics. Even iron material, steel alloy and stainless steel alloy that belong to pan-iron metal show different characteristics. For example, iron has magnetic property but the regular stainless steel does not have magnetic property.

Therefore, although there is the convenience of one stop service to recycle simultaneously all kinds of metals, yet it is full of challenges to recycle and reproduce on many different metals at the same time. Even if it is divided into noble metal and non-noble metal for recycling and reproduction, yet the recycling and reproduction process is complicated and tedious, for example, different chemicals, solutions and filtering layers and equipments have to be used.

Such complicated process means that different recycling and reproduction process will generate different solutions and by-product. This will need relatively large expense on equipment, labor and material to handle these solutions, waste water and by-product, generally speaking, simultaneous recycling of all kinds of metals not only represents complicated recycling engineering and quality control, but also represents high operation cost.

Therefore, the inventor of the present-invention, in order to avoid the complicated recycling engineering met in the above mentioned metallic recycling and reproduction engineering, the quality control issue in reproduced metal and the high recycling cost issue, tries to solve the problem from its root so as to cope with limited metallic resource issue and to enhance metallic recycling and reproduction efficiency. The inventor has done lots of research with the application of principle and long time of production and repeated test to propose one ferrous metal recycling and regeneration equipment. Through improved process equipment, the recycling and reproduction of ferrous metal can be simplified, the defective rate can be reduced, the cost can be greatly reduced, and high quality ferrous metal of Ferric Phosphate can be obtained. It is thus a reasonable invention that can effectively improve the above defects.

### SUMMARY OF THE INVENTION

The objective of the present invention is to provide one ferrous metal recycling and regeneration equipment, then through improved process equipment, ferrous metal recycling and regeneration process can be simplified, defective rate can be reduced, cost can be greatly reduced, and high quality Ferric Phosphate can be obtained.

In order to achieve the above objective, the present invention is mainly to provide one ferrous metal recycling and regeneration equipment, which comprising of: a recycled material storage tank, an acid dissolving tank, a first filtering device, a mixing tank, a second filtering device and a flash dryer. The acid dissolving tank has an opening part and an effluent hole, and the opening part can be placed with recycled material and added with acid solution, and the effluent hole can be used for the solution to flow out; the first filtering device has at least one filtering layer to filter out the impurity in the solution, and the second filtering device contains both internal and external layers, then through centrifugal force, the object is then separated in different grades, and the flash dryer contains a heating part.

Furthermore, the recycled ferrous metal is stored at the recycled material storage tank, then the acid dissolving tank is added with acidic solution, then ferrous metal is poured in, and non-ferrous metal impurity is removed through acidic cleaning, then through the first filtering device to filter out the impurity, ferrous metal solution is guided to the mixing tank, in mixing tank, phosphorus element (P) is added so that iron and phosphorus can compound into Ferric Phosphate (FePO₄.nII2O, where n can be 2 or 4), then the Ferric Phosphate solution is guided into the separation tank, then through the centrifugal action, the second filtering device will separate Ferric Phosphate in different grades, then it will be stored in placement area, then separated Ferric Phosphate will be guided into the flash dryer, finally, through the heating of the heating part, Ferric Phosphate is obtained.

For the advantages and spirit regarding the present invention, further understanding can be achieved through the following detailed description and attached drawings of the present invention.

### BRIEF DESCRIPTION OF THE DRAWINGS

FIG. 1 is an illustration of the present invention.

FIG. 2 is an illustration of preferred embodiment of the present invention.

### DETAILED DESCRIPTION OF THE INVENTION

In order to let your esteemed examiner can further understand the technique, means and effectiveness taken by this invention in order to achieve the expected goal, please refer to the following detailed description and attached drawings related to this invention. It is believed that the objective, features and characteristics of this invention should be understood in detailed and more specifically, however, the attached drawing is only for reference and description purpose instead of limiting this invention.

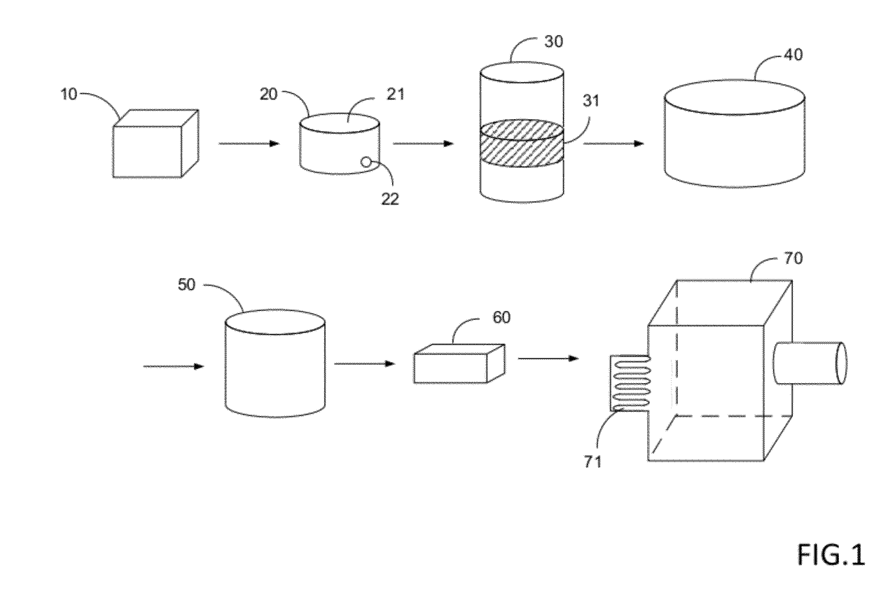

FIG. 1 is an illustration of the present invention. All the waste irons recycled from everywhere are placed in recycled material storage tank 10. Acid dissolving tank 20 contains opening part 21 and effluent hole 22. The recycled iron material placed in recycled material storage tank 10 is placed into acid dissolving tank 20 through opening part 21. Then through opening part 21, acidic solution is added into acid dissolving tank 20, and acid solution is used to dissolve the impurity.

The mixing solution of acid solution and recycled iron material will flow out from effluent hole 22. The mixing solution will enter first filtering device 30, then it will flow through filtering layer 31, and through filtering layer 31, impurity in the solution is removed. The filtered recycled iron mixing solution is then introduced into mixing tank 40. In the mixing tank, P element is added, iron will then chemically react with P element to get Ferric Phosphate (FePO₄.nH2O, where n can be 2 or 4). The PH is then adjusted to suitable value so that Ferric Phosphate will get precipitated, at this moment, the color of the precipitated powder is of milk white, light yellow color or light green, then Ferric Phosphate solution is introduced into second filtering device 50.

Second filtering device 50 will, through centrifugal force, separate Ferric Phosphate from the above mentioned recycled iron material mixing solution, and the separation will be in different grades. The separated Ferric Phosphate will be stored first in placement area 60, then it will be introduced into flash dryer 70, then it will be heated by heating part 71 so that the above mentioned Ferric Phosphate will be dried to get solid Ferric Phosphate. Ferric Phosphate can be used in the preparation of Li battery, and it is indispensible power source for the modern digital 3C product.

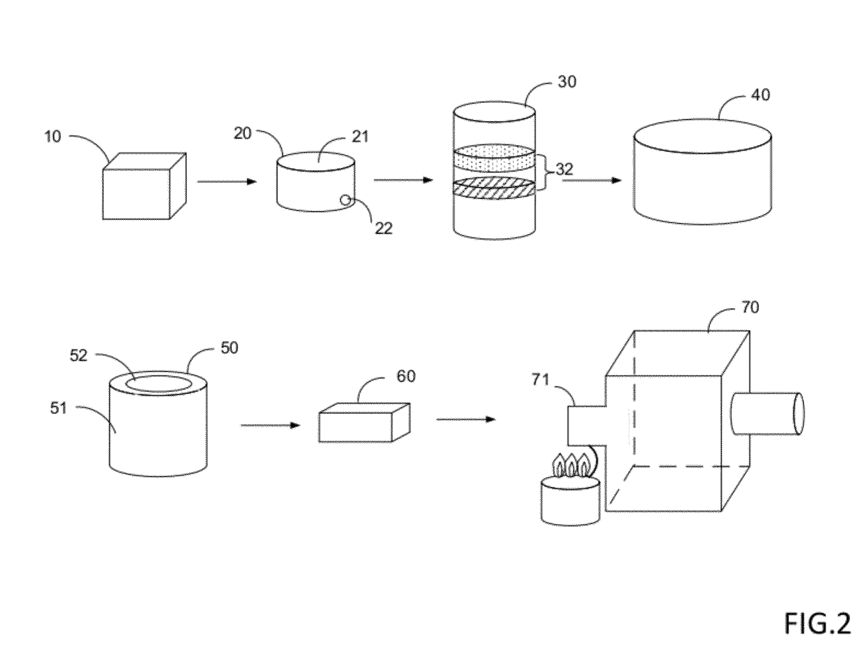

The preferred embodiment of the present invention is as in FIG. 2. The waste iron materials recycled from iron factories everywhere are placed in recycled material storage tank 10. Acid dissolving tank 20 contains opening part 21 and effluent hole 22, the recycled iron placed in recycled material storage tank 10 is placed into acid dissolving tank 20 through opening part 21. Meanwhile, acid solution is added through opening part 21 into acid dissolving tank 20, and acid solution is used to dissolve the impurity.

The mixing solution of acid solution and recycle iron material flows out from effluent hole 22. Mixing solution will enter first filtering device 30 and flow through filtering layer 32, then through filtering layer set 32, impurity in the solution is then removed. The filtered recycled iron material mixing solution is then introduced into mixing tank 40. In mixing tank, P element is added, and its PH value is adjusted to suitable value so that acidic iron powder will get precipitated, and iron will then react with P element chemically to get Ferric Phosphate (FePO₄.nH2O, where n can be 2 or 4), at this moment, the precipitated powder is of milk white, light yellow or light green. Then the Ferric Phosphate solution is introduced into second filtering device 50.

Columnar second filtering device 50 contains outer layer 51 and inner layer 52, through centrifugal force, it separates Ferric Phosphate from the above mentioned recycled iron material mixing solution in different grade. The separated Ferric Phosphate is then stored in placement area 60, then it is introduced into flash dryer 70, and heating part 71 is heated by the combustion of gas to get solid Ferric Phosphate, which can meet the high quality fertilizer need in the modern biotech agricultural product.

Therefore, the present invention can, through the above disclosed technique, provide improved process equipment, aiming at the recycling and reproduction of ferrous metal, to simplify the recycling and reproduction process, to reduce the entire recycling defective rate, to reduce greatly the recycling and reproduction cost, and to get high quality Ferric Phosphate.

While the foregoing is directed to embodiments of the present invention, other and further embodiments of the invention may be devised without departing from the basic scope thereof, and the scope thereof is determined by the claims that follow.

What is claimed is:

1. One ferrous metal recycling and regeneration equipment, comprising:
a recycled material storage tank, an acid dissolving tank, a first filtering device, a mixing tank, a second filtering device and a flash dryer,
the acid dissolving tank contains an opening part and an effluent hole, the opening part can be used for the recycled material place-in and for the acid solution adding, and the effluent hole can be used for the solution to flow out;
the first filtering device contains at least one filtering layer to filter out the impurity in the solution;
the second filtering device contains inner and outer layers, and through centrifugal force, the object is separated in different grades;
the flash dryer contains a heating part;
recycled ferrous metal is stored in the recycled material storage tank, and acid solution is added to the acid dissolving tank, then ferrous metal is poured in, and impurity of non-ferrous metal is cleaned in acid solution for removal, then first filtering device is used to filter out the impurity, ferrous metal solution is then introduced into the mixing tank, then P element is added into mixing tank so that Fe and P will compound into Ferric Phosphate (FePO₄.nH2O, where n can be 2 or 4), then Ferric Phosphate solution is introduced to the second filtering device, then through centrifugal force action, Ferric Phosphate is separated in different grades, then the separated Ferric Phosphate is introduced into the flash dryer, finally, through the heating of the heating part, Ferric Phosphate can be obtained.

2. The ferrous metal recycling and regeneration equipment of claim 1 wherein the second filtering device is columnar object.

3. The ferrous metal recycling and regeneration equipment of claim 1 wherein the inner and outer layer of second filtering device is of concentric cylindrical body.

4. The ferrous metal recycling and regeneration equipment of claim 1 wherein the heating part is of electric heating.

5. The ferrous metal recycling and regeneration equipment of claim 1 wherein the heating part is of gas heating.
